(19) United States
(12) Patent Application Publication
(10) Pub. No.: US 2024/0194086 A1
(43) Pub. Date: Jun. 13, 2024

(54) DEVICES AND METHODS FOR FACILITATING LEARNING BY MERGING TEXT WITH MUSIC

(71) Applicant: Beau Parmenter, Henderson, MI (US)

(72) Inventor: Beau Parmenter, Henderson, MI (US)

(21) Appl. No.: 18/509,144

(22) Filed: Nov. 14, 2023

Related U.S. Application Data
(60) Provisional application No. 63/383,591, filed on Nov. 14, 2022.

(51) Int. Cl. G09B 5/04; G06F 40/151; G06F 40/174; G10H 1/00

(52) U.S. Cl. CPC G09B 5/04; G06F 40/151; G06F 40/174; G10H 1/0025; G10H 2210/056; G10H 2210/111

(57) ABSTRACT

Described herein are computer implemented methods and computer systems for merging a selected text with a selected musical composition. The method or the steps performed by the computer system may include: receiving a selected text and a selected musical composition; dividing the selected musical composition into components and generating a blueprint of the selected musical composition; transforming the selected text into phoneme representations; merging the blueprint and the transformed text; and outputting a merged song.

### CROSS-REFERENCE TO RELATED APPLICATION

This application claims the priority benefit of U.S. Provisional Application No. 63/383,591, filed on Nov. 14, 2022, the disclosure of which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of facilitating learning by merging text and music or musical compositions. More specifically, described herein are systems and methods for merging user-selected text with user-selected music on-demand.

### BACKGROUND

It has been shown over the years that learning and comprehension can be improved by merging words or phrases with sounds or musical compositions. In particular, specific words or phrases are merged with music and replayed for greater engagement, memorization, and comprehension of those words and/or phrases. Traditionally, words and/or phrases are merged with predetermined musical compositions and used predominantly in lower school-grade classrooms. However, everyone at any age or learning environment could benefit from educational texts merged with music or musical compositions.

### SUMMARY

In a first general aspect

[symbol]

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 shows a block diagram of one embodiment of a system for implementing an application for merging text with music.

FIG. 2 shows a flowchart of one embodiment of selecting text and music for merging in an application configured to execute on a computing device.

FIG. 3 shows a block diagram of the computing device comprising a browser-based application for merging a selected text and music.

FIG. 4 shows a flowchart of one embodiment of an application for merging the received text with the selected musical composition.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

It has been shown over the years that learning and comprehension can be improved by merging words or phrases with sounds or musical compositions. In particular, specific words or phrases are merged with music and replayed for greater engagement, memorization, and comprehension of those words and/or phrases. Traditionally, words and/or phrases are merged with predetermined musical compositions and used predominantly in lower school-grade classrooms. However, everyone at any age or learning environment could benefit from educational texts merged with music or musical compositions. Accordingly, there exists a need for improved on-demand musical learning systems and methods for everyone.

In general, any of the applications, devices and methods described herein may merge received and/or selected text with user-provided and/or selected music or musical compositions. At a high level, the devices and methods described herein may include an application that may receive a desired text and music/composition and merge the text and music into a lyrical song that may be digitally executed for audio and visual playback on an electronic device capable of outputting audio data and visual data. The merged text and music may be digitally executed in a synchronized fashion for audio and visual playback that may be provided to a user to facilitate learning and/or memorization of particular text.

The text may include one or more of: words, phrases, stories, poems, educational books or documents, training manuals, scientific or technology documents, grammar books, etc., that may be accessed, captured, uploaded and/or stored in computing devices, such as a server, a remote computing device, a personal computer, and/or a mobile device. It will be appreciated that the text may be in any language, such as English, French, Spanish, etc. The text may be in a digital format, immediately available for merging, as would be the case with plain text or text contained within parse-able data structures. The text may be in a digital format that may utilize additional extraction, de-encryption, and/or other analysis, as would be the case with electronic book formats such as EPUB. The text may also be in non-digital formats, such as printed or scanned images of pages, that may use optical character recognition (OCR) techniques, to convert the text into a digital format before merging.

The music or musical composition, which may also include lyrics, may include one or more of: pop or hit songs, top-40 songs, different genres (including, but not limited to: rock, country, pop, folk, etc.), classical arrangements, instrumentals, or other arrangement that may assist a user in learning text that is synchronized with upbeats, downbeats, or other portions of the music. The musical compositions may be uploaded, selected from a database, and/or captured from a streaming service. The music may include one or more tracks, one or more movements, an entire composition, portions of a composition, unabridged versions, abridged versions, one or more suites, etc. When available on a user's device, the music may be selected from locally stored locations including on one or more of: file systems, stored playlists, and other third-party applications (e.g., iTunes™, Spotify™, Pandora™, etc.). Once selected, the music may either be processed and merged with selected text locally on-device or uploaded to a remote computing device. For music not on the user's device, the user may select music from a streaming service, online playlist, or other remote music database. The application may then obtain access to the selected music either via file download or a streamed connection, by using direct file access or indirect file access via a unique identifier (such as a Uniform Resource Locator or URL) that represents the music and allows for later complete download or streaming of the music. The selected music may either be downloaded or streamed and processed locally on-device or may be transmitted (directly via file/stream or indirectly via identifier) to a remote computing device for subsequent processing.

The application, along with the devices and methods, may be accessible to one or more users in an on-demand architecture. In some embodiments, devices executing the application described herein, which may be either wholly or partially installed on a local device and/or remotely accessed via the Internet, may interact with a user desiring an on-demand merging of text with music. It will be appreciated that the application may be downloaded, installed, and/or accessed via a browser-based interface or the like. It is envisioned that the merged song may then be downloaded, installed, and/or accessed remotely by the user or other users having access to the application and/or data described herein.

Further, the application described herein can partially or wholly reside and/or operate on one or more devices. For example, any one or more portions of the methods described herein may be performed locally (e.g., on a user computing device), remotely, for example on a secondary computing device or on a server, or a combination thereof. In some embodiments, a user device, which may be a smartphone, laptop, personal computer, etc., may download the application that includes algorithms for merging text with music. In some embodiments, the user device may communicate with an installed application on a local computer that performs the processing of merging of text with music. In some embodiments, the user device and/or local computer communicates with a browser-based software application residing on a server and/or computing device that performs the processing of merging text with music. Further, it will be appreciated that the application and devices may be configured differently. More specifically, the application described herein may operate as a hybrid software application that operates across one or more devices differently depending upon the processing capabilities of the devices. Other devices that may be utilized with the present disclosed subject matter may include displays, monitors, microphones, speakers, scanners, OCR readers, cameras, imaging sensors, etc., and will be discussed in further detail herein.

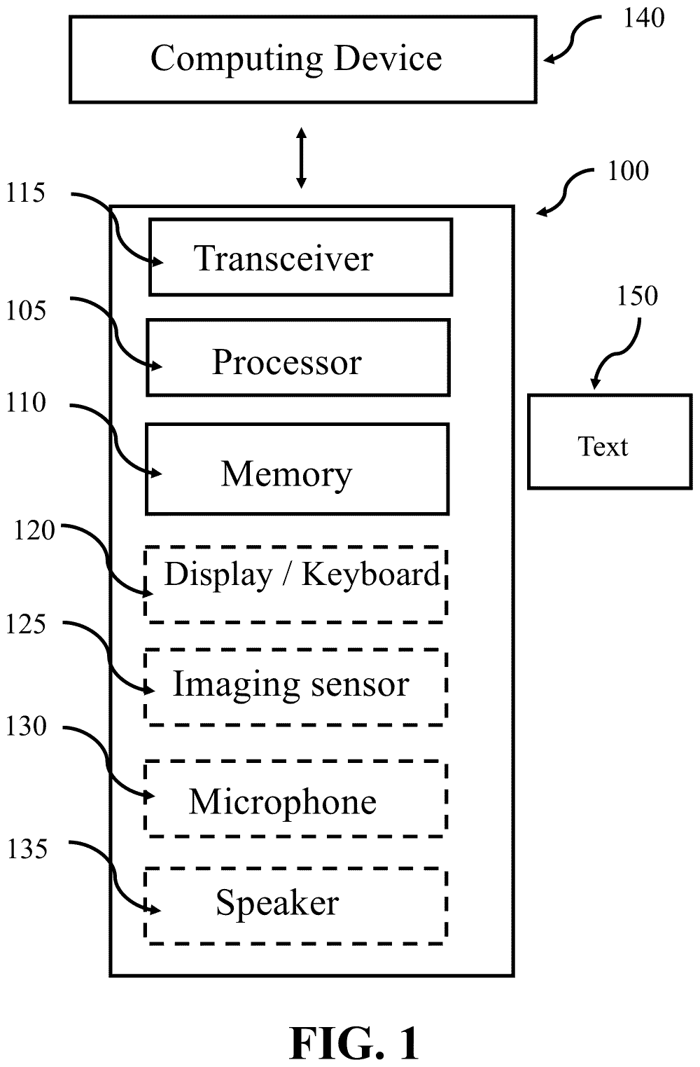

FIG. 1 shows a diagram of one embodiment of a system for implementing an application for merging text and music. As shown, a user device 100, such as a mobile phone, smartphone, laptop, home computer, smart television, smart watch, etc., may execute an application for selecting and playing a merged song. As used herein, the term “merged song” may include a selected text and a selected musical composition that have been synchronized together to form an audio and visual representation that combines the selected text and the selected musical composition according to a set of rules.

The user device 100 may include a processor 105 for executing the application and receiving selections and/or instructions, memory 110, a transceiver 115 for transmitting and receiving data associated with the application; an optional display and/or keyboard 120, an optional imaging sensor 125, such as a camera or OCR reader, an optional microphone 130, and an optional speaker 135. In some embodiments, the various components of the user device 100 may be incorporated into one device, such as shown in FIG. 1, or the components of the user device 100 may be separate devices, such as coupled displays, speakers, microphones, scanners, OCR readers, cameras, etc. The user device 100 may interact with a remote computing device 140 in order to request and download the application described herein. The application may wholly or partially reside on the user device 100. For example, the application stored in memory 110 of the user device 100 may process a user's request to merge text and music and provide the resulting merged song. In some embodiments, the application may execute basic operations and transmit data to the computing device 140, which processes the received data and provides the resulting merged song to the user device 100. In some embodiments, the user device 100 may interact with a browser-based, or web-based, application that resides completely on the remote computing device 140. In this manner, the user device 100 accesses the application via the Internet.

Still referring to FIG. 1, text 150, which may include one or more of: words, phrases, stories, poems, educational books or documents, training manuals, scientific or technology documents, grammar books, etc., may be selected, accessed, and/or captured by the user device 100. The text 150 may be in non-digital formats, such as printed or scanned images of pages, that may use a camera or on-the-fly optical character recognition (OCR) techniques, to transform the text into a digital format before merging. In general, the imaging sensor 125 may capture an image of the selected printed text 150 for the application to digitize prior to merging with a musical composition. It will be appreciated that the application may reside in memory 110 and be accessible to the processor 105.

In some embodiments, the captured image of the text 150 is digitized remotely (e.g., on a server) and then received via a transceiver 115 and uploaded to the application for processing, either on a secondary remote computing device 140 or a local computing device. In such an embodiment, the captured image may be processed at a server or remote computing device using optical character recognition to extract the text 150. The text 150 may then being transmitted via the transceiver 115 to the computing device 140 for further processing.

Alternatively, in some embodiments, the captured image of the text 150 is digitized locally (e.g., at the user computing device 100) and then further processed by the application on user computing device 100.

Alternatively, in some embodiments, the captured image of the text 150 is digitized on a secondary computing device and then further processed by the application on the secondary computing device or transmitted to the user computing device 100 or a remote computing device (e.g., server) for further processing.

In some embodiments, the captured image is transferred to a personal computer (not shown), which may execute the application. The text 150 may also be in a digital format immediately available for selecting and uploading, as would be the case with plain text or text contained within parse-able data structures. The text 150 may be selected, for example by digitally highlighting, the desired text. The application may then encapsulate and format the selected text for transmission to the computing device 140. Further, the text 150 may be in a digital format that requires additional extraction, as would be the case with electronic book formats, such as EPUB, which is an e-book file format used with e-readers, tablets, and smartphones. In this embodiment, the selected portion of the text 150 may be highlighted or otherwise captured by the application for further processing. Further, the text 150 may also be captured by the microphone 130 and converted into a text format for processing.

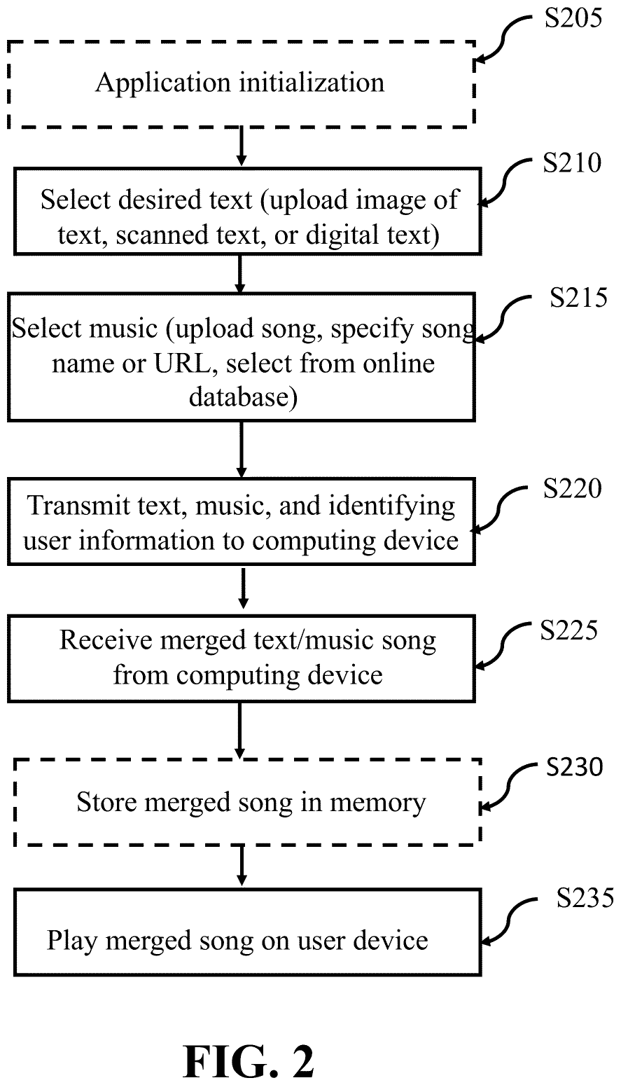

FIG. 2 shows a flowchart of one embodiment of selecting text and a musical composition for merging via the application. At S205, the user device 100 may initialize the application. At S210, a user selects the desired text 150 either by enabling the user device 100 to capture an image, scan, read, or highlight the text. As previously mentioned, the user device 100 may also capture the text 150 using the microphone 130. At S215, the user selects a desired music or musical composition. The user device 100 may capture the music by selecting a song that is playing, presenting the user with a user input field for entering a name of a song and/or entering a location of a stored song, such as in a remote database, an online address (e.g., uniform resource locator (URL)), internal memory, a music application, etc. The user device 100 may transmit the captured text and selected music information, optionally along with user identifying information (e.g., when the user has a user account associated with a music repository), to the computing device 140 for processing and merging the text and music at S220. At S225, the user device 100 receives the merged text and music song from the computing device 140. Optionally, the user device 100 may store the merged song in memory 130. Alternatively or additionally, the user device 100 may stream the merged song from the computing device 140. Alternatively or additionally, the user device 100 may upload the merged song to another computing device 140. At S235, the user device 100 then plays the merged song.

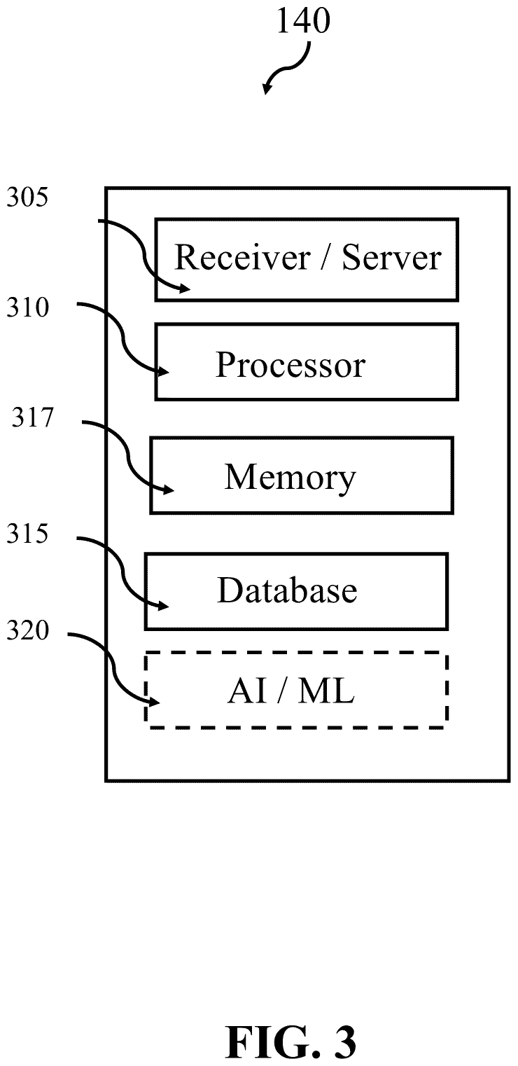

FIG. 3 shows a block diagram of the computing device 140 including a browser-based application for merging the selected text and music. A receiver and/or internal or external server 305 may receive the selected text, music, and optionally user identifying information from the user device 100. Memory 317 stores the user identifying information, at least temporarily, and processor 310 may merge the text and music, which is discussed further hereinbelow. The computing device 140 may also optionally include artificial intelligence and/or machine learning systems that process and merge the text and music.

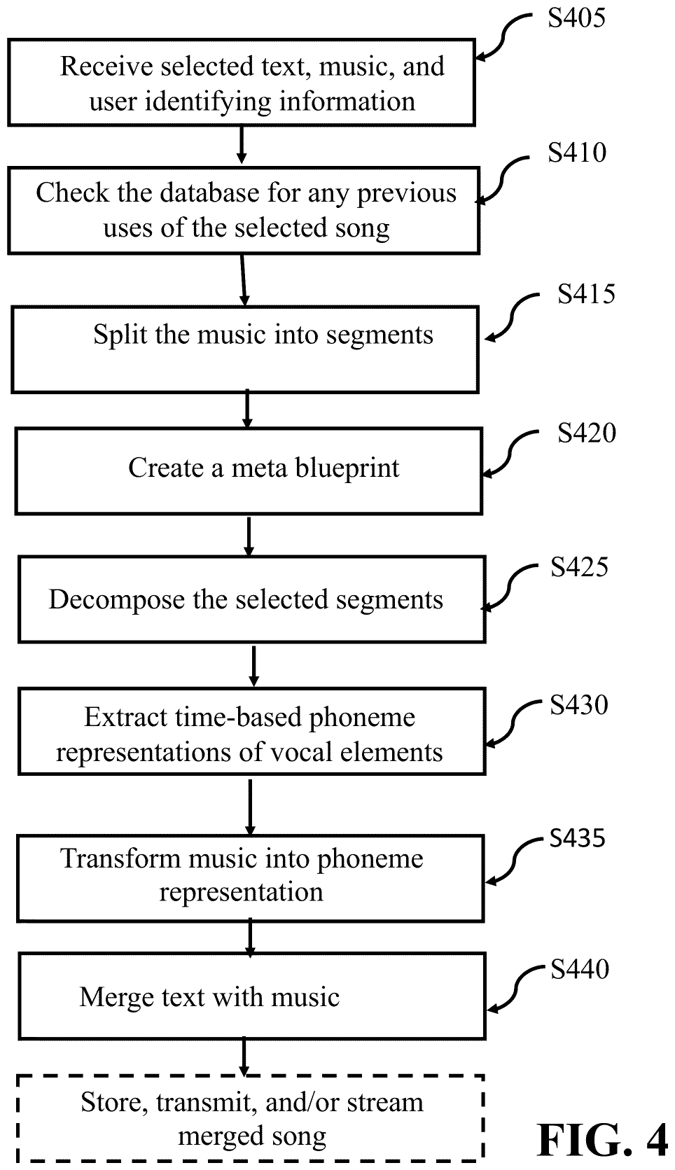

FIG. 4 shows a flowchart of one embodiment of a computer-implemented method for merging a received/selected text with a selected music or musical composition. In general, songs are time-based segments (e.g., tracks, movements, etc.) that can contain both instruments and vocal elements, performed together as a melody or a composition. A segment may include one note or beat or word or phrase, one or more notes or beats or words or phrases, or a plurality of notes or beats or words or phrases.

At block S405, the application receives the user's selected text, music, and optionally user identifying information. The application may check the database 315 at block S410 to determine whether the application has already generated and stored a blueprint for the selected segment and, if so, proceeds to block S435 in order to use that existing blueprint for subsequent processing and merging. For example, as used herein, a “blueprint” may include: a data structure that describes the decomposition structure of a selected music or segment of the music; a relationship between components (e.g., phonemes, time, pitch) of a selected music; and/or a collection of records that preserves a relationship between the components of the selected music (e.g., that may be stored in a table or relational database). Non-limiting examples of input formats or digital representations of a “blueprint” include: tables, text files, key-value stores, dictionaries, plain text delimited data stores, and human readable, encoded object or markup-based document formats such as JSON (JavaScript Object Notation) or XML (Extensible Markup Language). For example, any of the aforementioned formats may be used for blueprint caching, for example, to increase future processing speed.

If a blueprint does not exist or is not used, it can be generated. To facilitate the merging of the selected new text with existing instrumental music while preserving some level of melodic approximation, the application may process each segment to: 1) effectively divide the segment into constituent digital audio components at block S415 and 2) generate a meta blueprint of the segment that may include time, pitch, and/or phoneme-based data at block S420. In some embodiments, dividing the selected musical composition into components includes dividing the musical composition into melody components and generating a blueprint of the musical composition according to the dividing.

At block S425, each selected track is parsed through a process of music source separation that decomposes the music into its primary stems, or components, with the primary focus being on separation of vocal elements from instrumental elements. This separation process could use methods including more traditional approaches, such as phase cancellation, and more modern approaches, such as AI and ML-based separation engines 320. At block S430, lyrical vocal elements from the separated segment are digitally processed to extract time-based phoneme representations. Using digital signal processing, the vocal elements are also musically transcribed, providing time-based pitches (in semitones, for example). Music transcription occurs after source separation to simplify pitch detection by turning the transcription input into a source closer to monophonic music. This simplifies the spectrogram for note detection algorithms and makes pitch detection into a simpler task, as note detection from polyphonic recordings still remains a largely unsolved problem. The application now has a blueprint for the segment comprising time-based lyrical phonemes and pitches. This blueprint will be used by subsequent merging at block S440, but can also be stored on the user device 100, the computing device 140, and/or a remote computing device, for example to improve performance for subsequent uses of this song by this user or anyone else within the entire user base of the application. In some embodiments, the blueprint may be used as input to one or more ML layers 320 to train the layers to generate blueprints from additional music or musical compositions. When the musical composition does not include vocal elements, the musical composition may be decomposed into rhythmic segments or individual measures (e.g., determined based on the time signature) that can be paired with portions or subsets of the selected text.

At block S435, either concurrently, subsequently, or prior to the music processing (S410-S430), the selected text to be merged into the instrumental track element is also algorithmically transformed into its phoneme-based representation. Using the track blueprint, these phonemes can now be mapped, or merged, at block S440 directly over the original lyric-based phonemes from the previously processed vocal track, essentially using the original lyric-based phonemes as fillable bins for the educational text. The merged song can now be sung back by a computing device, via methods including text-to-speech (TTS) synthesis, using the text-based phoneme, pitch, and time inputs.

In some embodiments, merging the blueprint and the transformed text to generate a merged song includes synthesizing the melody components from the blueprint with the phoneme representations. In some embodiments, synthesizing may include syncopating the melody components with the phoneme representations. In some embodiments, synthesizing may include mapping upbeats and/or downbeats of the melody components with the phoneme representations. In some embodiments, synthesizing may include any combination of matching the melody components with the phoneme representations according to predefined rules.

When overlayed atop the extracted instrumental stem, using the pitches and timings extracted from the original vocals, the synthesized phonemes from the educational text can achieve melodic approximation with the original source music segment. It should be noted that using audio samples from original artist vocals could enable use of deep fake technology to make the new synthesized text sound more like the original artist when sung in its new form. At block S445, the merged song may be stored at the computing device 140; the processed music stored in the database 315 and/or used as a training element for a ML layer system 320; transmitted to the user device 100; and/or be available for streaming in the system.

The systems and methods of the embodiments described herein and variations thereof can be embodied and/or implemented at least in part as a machine configured to receive a computer-readable medium storing computer-readable instructions. The instructions may be executed by computer-executable components preferably integrated with the system and one or more portions of the processor on the mobile device, computer, and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

As used in the description and claims, the singular form “a”, “an” and “the” include both singular and plural references unless the context clearly dictates otherwise. For example, the term “user device” may include, and is contemplated to include, a plurality of user devices in the system. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for merging of selected text with a selected musical composition, the method comprising:
receiving a selected text and a selected musical composition;
dividing the selected musical composition into melody components and generating a blueprint of the selected musical composition according to the dividing;
transforming the selected text into phoneme representations;
merging the blueprint and the transformed text to generate a merged song, the merged song being generated by synthesizing the melody components from the blueprint with the phoneme representations; and
outputting the merged song.

2. The method of claim 1, wherein the merging is performed on demand in response to a request to generate the song.

3. The method of claim 1, wherein the selected text is received in the form of non-digital text captured by one or more of: an imaging sensor, a camera, a scanner, or an optical character recognition device, wherein the method further comprises, digitizing the non-digital text.

4. The method of claim 1, wherein receiving the selected text comprises detecting a capture of a selection of digital text by one or more of: a digital highlighting of the text or detecting entry of a specified online address of the text; and
wherein the method further comprises uploading the captured digital text.

5. The method of claim 1, wherein receiving the selected text comprises detecting audio indicating selection of the selected text.

6. The method of claim 1, wherein receiving the selected musical composition comprises detecting one or more of: uploading a musical composition; receiving an input comprising a name of a musical composition; receiving an input comprising an online address associated with a musical composition.

7. The method of claim 1, wherein the selected musical composition comprises one of: a song with lyrics; a song without lyrics; an orchestral song; a partial song; or a complete song.

8. The method of claim 1, wherein the selected text comprises one or more of: words, phrases, stories, poems, educational books or documents, training manuals, scientific or technology documents, and grammar books.

9. A computer system for merging a selected text with a selected musical composition, the computer system comprising:
an interface circuit;
a processor coupled to the interface circuit;
memory, coupled to the processor, storing program instructions, wherein, when executed by the processor, the program instructions cause the computer system to perform operations comprising: receiving a selected text and a selected musical composition;
dividing the selected musical composition into melody components and generating a blueprint of the selected musical composition according to the dividing;
transforming the selected text into phoneme representations;
merging the blueprint and the transformed text to generate a merged song, the merged song being generated by synthesizing the melody components from the blueprint with the phoneme representations; and
outputting the merged song.

10. The system of claim 9, wherein the merging is performed on demand in response to a request to generate the song.

11. The system of claim 9, wherein the selected text is received in the form of non-digital text captured by one or more of: an imaging sensor, a camera, a scanner, or an optical character recognition device, wherein the operations further comprise, digitizing the non-digital text.

12. The system of claim 9, wherein receiving the selected text comprises detecting a capture of a selection of digital text by one or more of: a digital highlighting of the text or detecting entry of a specified online address of the text, wherein the operations further comprise uploading the captured digital text.

13. The system of claim 9, wherein receiving the selected text comprises detecting audio indicating selection of the selected text.

14. The system of claim 9, wherein the selected musical composition comprises one of: a song with lyrics; a song without lyrics; an orchestral song; a partial song; or a complete song.

15. The system of claim 9, wherein the selected text comprises one or more of: words, phrases, stories, poems, educational books or documents, training manuals, scientific or technology documents, and grammar books.

16. A non-transitory computer-readable storage medium for use in conjunction with a processor the computer-readable storage medium storing program instructions that, when executed by the processor, cause the processor to carry out one or more operations comprising:
receiving a selected text and a selected musical composition;
dividing the selected musical composition into melody components and generating a blueprint of the selected musical composition according to the dividing;
transforming the selected text into phoneme representations;
merging the blueprint and the transformed text to generate a merged song, the merged song being generated by synthesizing the melody components from the blueprint with the phoneme representations; and
outputting the merged song.

17. The non-transitory computer-readable storage medium of claim 16, wherein the selected text is received in the form of non-digital text captured by one or more of: an imaging sensor, a camera, a scanner, or an optical character recognition device, wherein the operations further comprise, digitizing the non-digital text.

18. The non-transitory computer-readable storage medium of claim 16, wherein receiving the selected text comprises detecting a capture of a selection of digital text by one or more of: a digital highlighting of the text or detecting entry of a specified online address of the text, wherein the operations further comprise uploading the captured digital text.

19. The non-transitory computer-readable storage medium of claim 16, wherein the selected musical composition comprises one of: a song with lyrics; a song without lyrics; an orchestral song; a partial song; or a complete song.

20. The non-transitory computer-readable storage medium of claim 9, wherein the selected text comprises one or more of: words, phrases, stories, poems, educational books or documents, training manuals, scientific or technology documents, and grammar books.
